(19) United States
(12) Patent Application Publication
(10) Pub. No.: US 2025/0290616 A1
(43) Pub. Date: Sep. 18, 2025

(54) VEHICLE HEADLIGHT ASSEMBLY WITH MULTI-ASPECT RATIO SOURCE PROJECTOR

(71) Applicant: Autosystems, a division of Magna Exteriors Inc, Aurora (CA)

(72) Inventors: Adam L. Bushre, Saranac, MI (US); Gaurav Bhutani, Whitby, Ontario (CA)

(21) Appl. No.: 19/074,939

(22) Filed: Mar. 10, 2025

Related U.S. Application Data
(60) Provisional application No. 63/565,936, filed on Mar. 15, 2024.

(51) Int. Cl. F21S 41/663; F21S 41/25

(52) U.S. Cl. CPC F21S 41/663; F21S 41/25

(57) ABSTRACT

A headlight assembly for a vehicle includes a spread pattern light source including a first plurality of pixel light sources and a first lens assembly overlying the spread pattern light source and configured to project the light from the spread pattern light source over a first field of view. The headlight assembly also includes a spot pattern light source including a second plurality of pixel light sources, and a second lens assembly overlying the spot pattern light source and configured to project the light from the spot pattern light source over a second field of view smaller than the first field of view and overlapping the first field of view. The first lens assembly and the second lens assembly each have substantially identical constructions.

### CROSS REFERENCE TO RELATED APPLICATIONS

This U.S. utility patent application claims the benefit of U.S. Provisional Patent Application No. 63/565,936, filed Mar. 15, 2024, the contents of which is incorporated herein by reference in its entirety.

### FIELD

The present disclosure relates generally to lighting for motor vehicles. More specifically, the present disclosure relates to headlights for passenger vehicles, such as cars and trucks, and which include pixel light sources.

### BACKGROUND

Headlight assemblies for vehicles are subject to regulations regarding a cut-off pattern in order to illuminate a roadway ahead of the vehicle while also minimizing disruption to drivers of other vehicles, including oncoming traffic and vehicles traveling ahead of and in a same direction as the subject vehicle. Several different regulations and standards for headlight illumination may apply in different jurisdictions.

Pixel light sources may provide configurable illumination patterns to meet various different regulatory requirements and/or to provide enhanced automatic control of the headlamps of a vehicle, such as dynamically adjustable beam patterns for high beam functions and/or for low-beam functions. However, two or more pixel light sources may be required to produce a desired illumination intensity, especially in specific regions, such as a central region of a field of view to illuminate the roadway ahead of the vehicle.

### SUMMARY

The present disclosure provides a headlight assembly for a vehicle. The headlight assembly includes a spread pattern light source including a first plurality of pixel light sources; and a first lens assembly overlying the spread pattern light source and configured to project the light from the spread pattern light source over a first field of view. The headlight assembly also includes a spot pattern light source including a second plurality of pixel light sources; and a second lens assembly overlying the spot pattern light source and configured to project the light from the spot pattern light source over a second field of view smaller than the first field of view and overlapping the first field of view. The first lens assembly and the second lens assembly each have substantially identical constructions.

The present disclosure also provides a lighting system for a vehicle. The lighting system comprises two headlight assemblies. Each of the headlight assemblies includes: a spread pattern light source including a first plurality of pixel light sources; and a first lens assembly overlying the spread pattern light source and configured to project the light from the spread pattern light source over a first field of view. Each of the headlight assemblies also includes: a spot pattern light source including a second plurality of pixel light sources; and a second lens assembly overlying the spot pattern light source and configured to project the light from the spot pattern light source over a second field of view smaller than the first field of view and overlapping the first field of view. The first lens assembly and the second lens assembly each have substantially identical constructions.

These and other aspects of the present disclosure are disclosed in the following detailed description of the embodiments, the appended claims, and the accompanying figures.

### BRIEF DESCRIPTION OF THE DRAWINGS

Further details, features and advantages of designs of the invention result from the following description of embodiment examples in reference to the associated drawings.

FIG. 1 shows a schematic block diagram of a vehicle with two headlight assemblies, in accordance with an aspect of the present disclosure;

FIG. 2 shows a cutaway perspective view of a headlight assembly and illustrating a combined field of view (FOV), in accordance with an aspect of the present disclosure;

FIG. 3 shows a cutaway top view of a high-beam (HB) spread source and a HB spot source of the headlight assembly, in accordance with an aspect of the present disclosure;

FIG. 4 shows a cutaway perspective view of the HB spread source and the HB spot source of the headlight assembly, in accordance with an aspect of the present disclosure;

FIG. 5 shows a diagram of a source emitting area and a corresponding far-field projection pattern, for a spread pattern light source with a 4:1 aspect ratio;

FIG. 6 shows a diagram of a source emitting area and a corresponding far-field projection pattern, for a spot pattern light source with a 3:1 aspect ratio;

FIG. 7 shows a diagram of a source emitting area and a corresponding far-field projection pattern, for a spot pattern light source with a 2:1 aspect ratio;

FIG. 8A shows an illumination pattern for a high-beam spread pattern illumination source, in accordance with an aspect of the present disclosure;

FIG. 8B shows an illumination pattern for a high-beam spot pattern illumination source, in accordance with an aspect of the present disclosure;

FIG. 8C shows a combined illumination pattern for a high-beam spread pattern light source and a high-beam spot pattern illumination source, in accordance with an aspect of the present disclosure;

FIG. 9 shows an on-road illumination pattern for a spread pattern light source with a 4:1 aspect ratio, in accordance with an aspect of the present disclosure;

FIG. 10 shows an on-road combined illumination pattern for a spread pattern light source with a 4:1 aspect ratio together with a spot pattern light source with a 3:1 aspect ratio, in accordance with an aspect of the present disclosure; and

FIG. 11 shows an on-road combined illumination pattern for a spread pattern light source with a 4:1 aspect ratio together with a spot pattern light source with a 2:1 aspect ratio, in accordance with an aspect of the present disclosure.

### DETAILED DESCRIPTION

Referring to the drawings, the present invention will be described in detail in view of following embodiments.

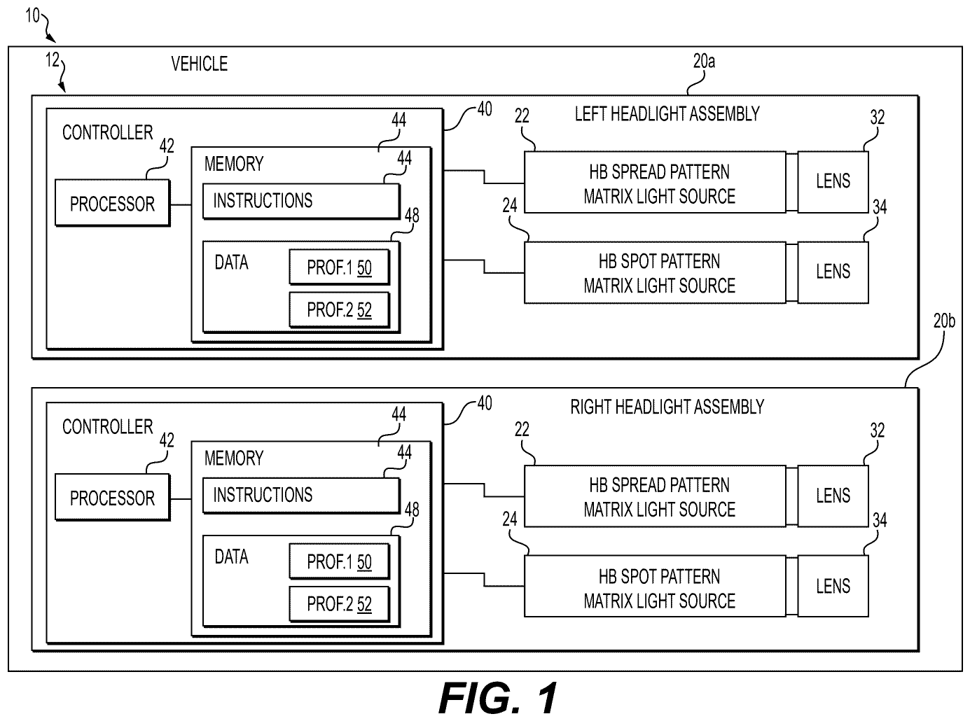

FIG. 1 shows a schematic block diagram of a vehicle 10 with a first lighting system 12, according to an aspect of the present disclosure. The vehicle 10 may be a motor vehicle, such as a passenger car or truck. However, the headlamp assembly of the present disclosure may be applicable to other types of vehicles, such as commercial trucks, busses, trains, etc. The vehicle 10 with the first lighting system 12 of the present disclosure may also be referred to as the ego vehicle or the subject vehicle. The first lighting system 12 includes a left-side headlight assembly 20a and a right-side headlight assembly 20b. Each of the headlight assemblies 20a, 20b may be similar or identical to one-another. In some embodiments, the headlight assemblies 20a, 20b may include similar or identical internal components and different external components, such as a housing that is configured to fit within the structure on the corresponding side of the vehicle 10.

As shown in FIG. 1, each of the headlight assemblies 20a, 20b includes a spread pattern light source 22 and a spot pattern light source 24. The spread pattern light source 22 may also be called a base light source or a foreground base light source and may include a first plurality of pixel light sources, which may be individually controllable, and which define a first aspect ratio. The spot pattern light source 24 may include a second plurality of pixel light sources, which may be individually controllable, and which define a second aspect ratio. The second aspect ratio of the spot pattern light source 24 may be different from the first aspect ratio of the spread pattern light source 22. For example, the spread pattern light source the first aspect ratio of the spread pattern light source 22 may be 4:1 and the second aspect ratio of the spot pattern light source 24 may be 3:1 or 2:1. In some embodiments, and as shown in the drawings, either or both of the spread pattern light source 22 and/or the spot pattern light source 24 may be oriented with a larger width than a corresponding height.

In some embodiments, the first plurality of pixel light sources of the spread pattern light source 22 may include at least 1,000 pixel light sources, which may be individually controllable. Each of the pixel light sources may include an LED element, although other types of light emitting devices may be used for the pixel light sources. Each of the pixel light sources may have a pixel size of 0.04 mm and a resolution of 0.1°×0.1°. However, the pixel light sources may have a different pixel size and/or a different resolution. In some embodiments, the first plurality of pixel light sources of the spread pattern light source 22 may include at least 20,000 pixel light sources. For example, the spread pattern light source 22 may include 248 columns and 82 rows of micro LEDs to provide 20,336 total micro LEDs, each forming a pixel light source. In some embodiments, the first plurality of pixel light sources of the spread pattern light source 22 may include at least about 500,000 pixel light sources.

In some embodiments, the second plurality of pixel light sources of the spot pattern light source 24 may include at least 1,000 pixel light sources, which may be individually controllable. Each of the pixel light sources may include an LED element, although other types of light emitting devices may be used for the pixel light sources. Each of the pixel light sources may have a pixel size of 0.04 mm and a resolution of 0.1°×0.1°. However, the pixel light sources may have a different pixel size and/or a different resolution. In some embodiments, the second plurality of pixel light sources of the spot pattern light source 24 may include at least 20,000 pixel light sources. For example, the spot pattern light source 24 may include 248 columns and 82 rows of micro LEDs to provide 20,336 total micro LEDs, each forming a pixel light source. In some embodiments, the second plurality of pixel light sources of the spot pattern light source 24 may include at least about 500,000 pixel light sources.

Each of the headlight assemblies 20a, 20b also includes a first lens assembly 32 that is aligned with the spread pattern light source 22 to project the light therefrom outwardly in front of the vehicle 10. Each of the headlight assemblies 20a, 20b also includes a second lens assembly 34 that is aligned with the spot pattern light source 24 to project the light therefrom outwardly in front of the vehicle 10. In some embodiments the first lens assembly 32 and the second lens assembly 34 may each have substantially identical constructions. For example, the first lens assembly 32 and the second lens assembly 34 may be identical and interchangeable. Alternatively, the first lens assembly 32 and the second lens assembly 34 may have identical optical components, such as lens elements and/or a lens carrier, but different mounting brackets.

The spread pattern light source 22 and the first lens assembly 32 may be collectively called a high-beam (HB) spread source 22, 32. The spot pattern light source 24 and the second lens assembly 34 may be collectively called a HB spot source 24, 34. Each of the HB spread source 22, 32 and the HB spot source 24, 34 may be operable together in a high-beam mode to generate a combined high-beam projection pattern. However, the principles of the present disclosure may be applicable to other light sources for other functions within a vehicle headlight.

Each of the headlight assemblies 20a, 20b also includes a controller 40 in communication with each of the spread pattern light source 22 and the spot pattern light source 24. The controller 40 may also be called a headlamp smart lighting driver or a headlamp smart LED driver. The controller 40 may be configured to control a pattern of light generated by the spread pattern light source 22 and/or the spot pattern light source 24.

The controller 40 includes a processor 42 coupled to a storage memory 44. The storage memory 44 includes instruction storage 46 storing instructions, such as program code for execution by the processor 42. The storage memory 44 also includes data storage 48 for holding data for use by the processor 42. The data storage 48 includes a first profile data 50 and a second profile data 52 representing first and second patterns, respectively, to be generated by the spread pattern light source 22 and/or the spot pattern light source 24.

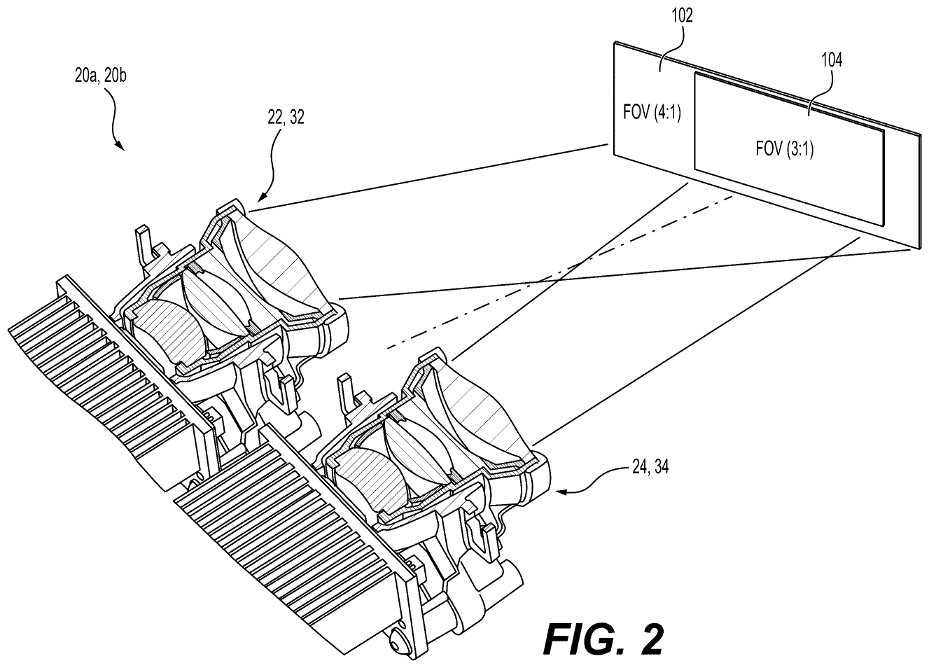

FIG. 2 shows a cutaway perspective view of a headlight assembly and illustrating a combined field of view (FOV) 102, 104. FIG. 2 shows the HB spread source 22, 32. projecting light as a spread pattern over a first FOV 102. FIG. 2 also shows the HB spot source 24, 34 projecting light over a second FOV 104 that is smaller than the first FOV 102 and overlapping the first FOV 102. In some embodiments, and as shown in FIG. 2, the first FOV 102 has a first aspect ratio of 4:1, meaning that it is 4-times wider than it is tall. In some embodiments, the first aspect ratio of the spread pattern light source 22 is greater than the second aspect ratio of the spot pattern light source 24. For example, and as shown in FIG. 2, the second FOV 104 may have a second aspect ratio of 3:1. Alternatively, the second FOV 104 may have a different second aspect ratio, such as 2:1.

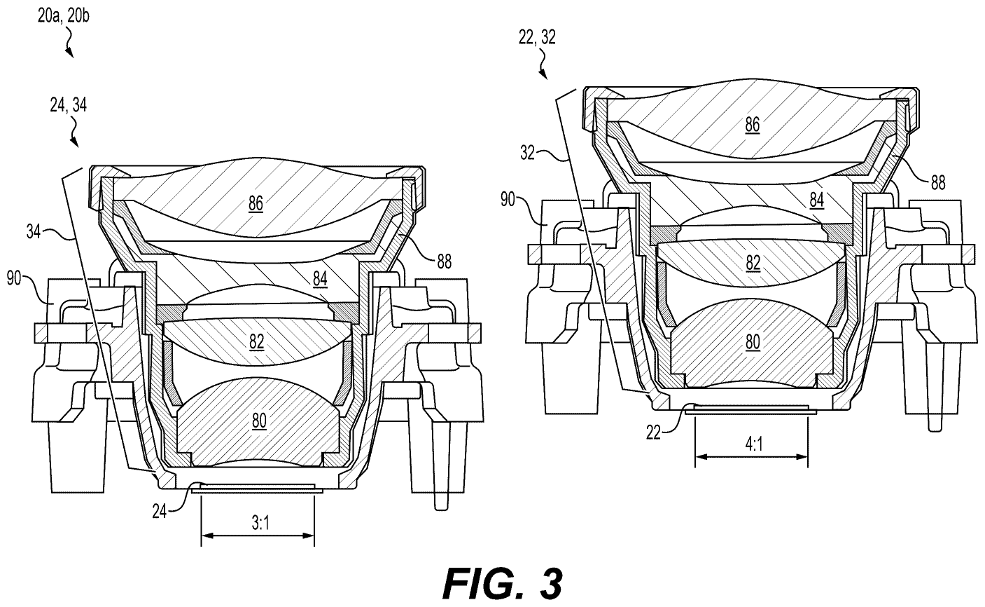

FIG. 3 shows a cutaway top view of the HB spread source 22, 32 and the HB the HB spot source 24, 34. As shown, the HB spread source 22, 32 includes the spread pattern light source 22 with a 4:1 aspect ratio to generate the first FOV 102 with the first aspect ratio of 4:1. The HB spread source 22, 32 also includes the first lens assembly 32 overlying the spread pattern light source 22. The first lens assembly 32 includes a first lens element 80, a second lens element 82, a third lens element 84, and a fourth lens element 86 in a series arrangement with light from the spread pattern light source 22 being focused and directed sequentially through each of the lens elements 80, 82, 84, 86. The first lens assembly 32 also includes a lens barrel 88 having a generally tubular shape and which is configure to hold each of the lens elements 80, 82, 84, 86 in predetermined positions relative to one-another and relative to the spread pattern light source 22. The HB spread source 22, 32 also includes a bracket 90 that holds the lens barrel 88 and a printed circuit board (PCB) containing the spread pattern light source 22.

As also shown in FIG. 3, the HB spot source 24, 34 includes the spot pattern light source 24 with a 3:1 aspect ratio to generate the second FOV 104 with the second aspect ratio of 3:1. The HB spot source 24, 34 also includes the second lens assembly 34 overlying the spot pattern light source 24. The first lens assembly 32 and the second lens assembly 34 may have a substantially identical constructions. In some embodiments, each of the lens elements 80, 82, 84, 86, the lens barrel 88, and the bracket 90 may be identical for each of the first lens assembly 32 and the second lens assembly 34. Alternatively, the first lens assembly 32 and the second lens assembly 34 may each have brackets 90 that are slightly different to accommodate differences between the spread pattern light source 22 and the spot pattern light source 24 and/or to accommodate different mounting positions within a corresponding one of the headlight assemblies 20a, 20b.

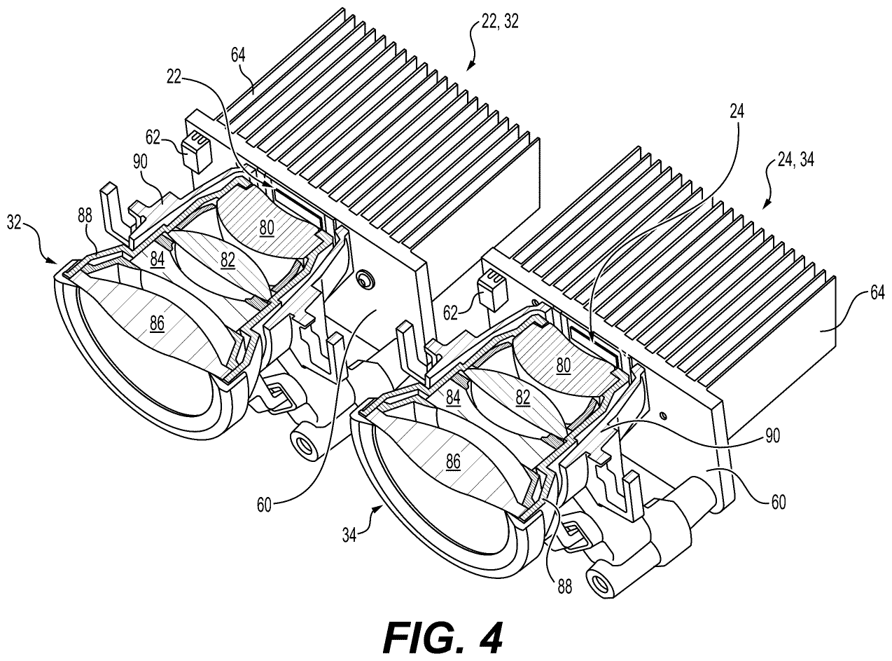

FIG. 4 shows a cutaway perspective view of the HB spread source 22, 32 and the HB spot source 24, 34 of the headlight assembly 20a, 20b, in accordance with an aspect of the present disclosure. As shown, each of the HB spread source 22, 32 and the HB spot source 24, 34 includes a corresponding one of the lens assemblies 32, 34, and each of the two lens assemblies 32, 34 are substantially identical. Each of the HB spread source 22, 32 and the HB spot source 24, 34 also includes a PCB 60 with an electrical connector 62 for providing power to the corresponding one of the spread pattern light source 22 and the spot pattern light source 24 and to physically hold the corresponding one of the spread pattern light source 22 and the spot pattern light source 24 in a fixed position relative to a corresponding one of the lens assemblies 32, 34. Each of the HB spread source 22, 32 and the HB spot source 24, 34 also includes a heat sink 64 attached to a back side of the corresponding PCB 60, opposite from the corresponding light source 22, 24 and for removing heat therefrom.

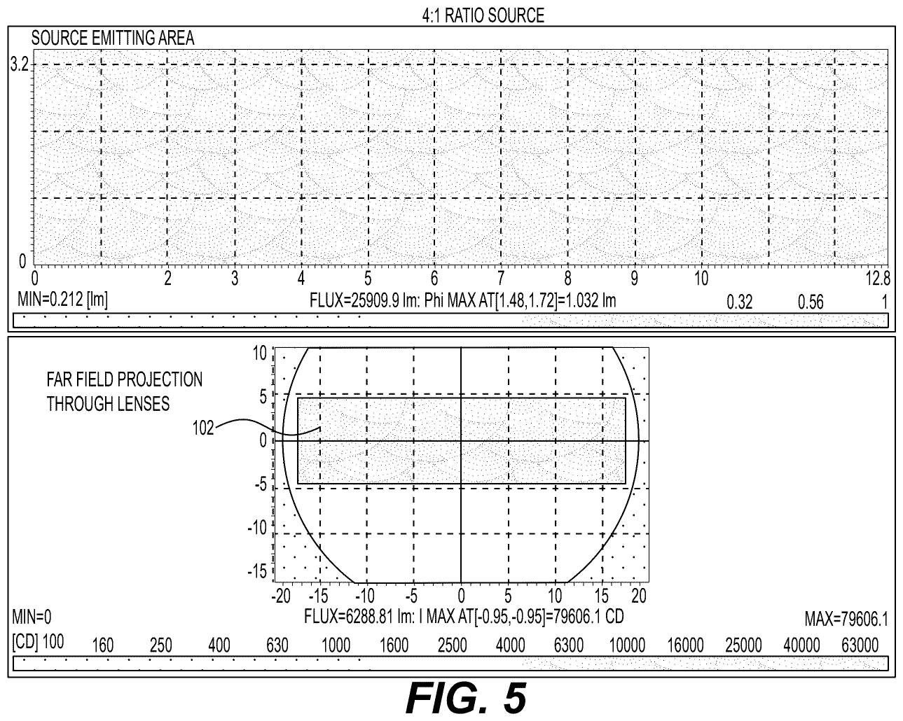

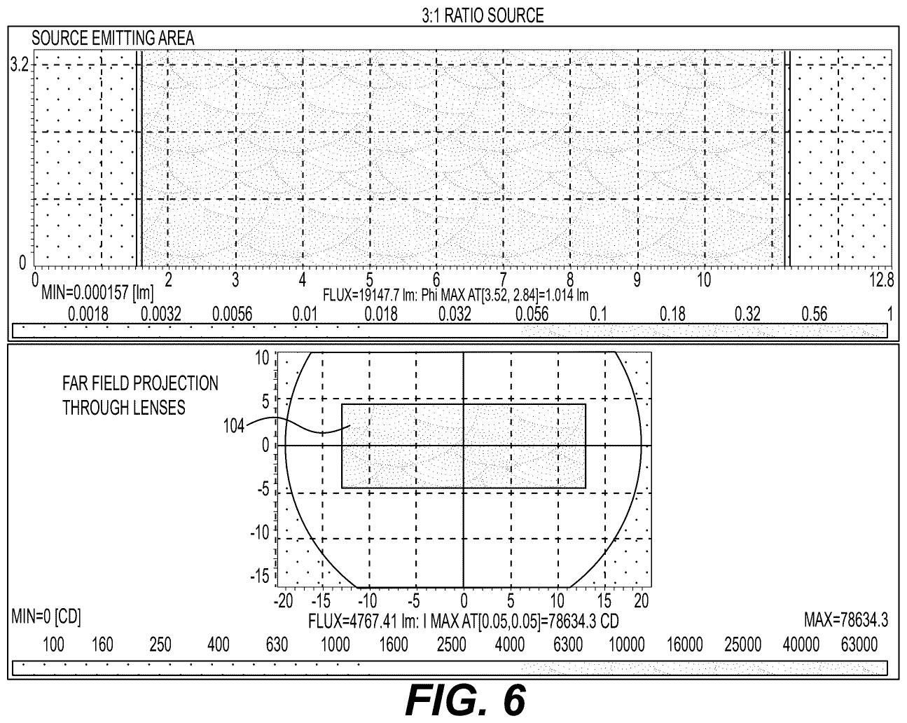

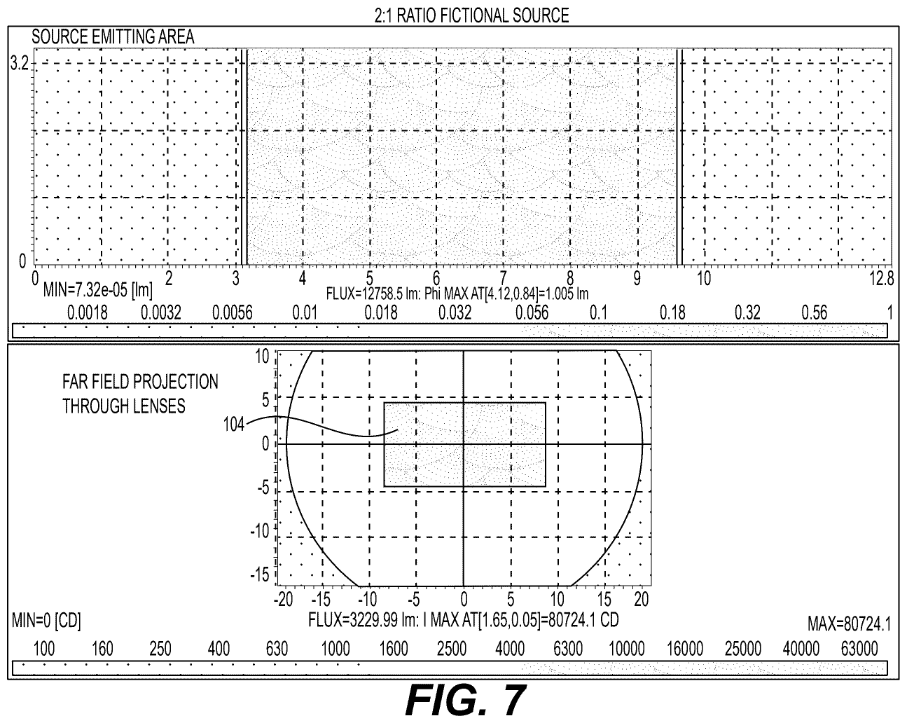

FIG. 5 shows a diagram of a source emitting area and a corresponding far-field projection pattern, for a spread pattern light source 22 with a 4:1 aspect ratio. As shown in FIG. 5, the first FOV 102 has a width of about 32-degrees. FIG. 6 shows a diagram of a source emitting area and a corresponding far-field projection pattern, for a spot pattern light source 24 with a 3:1 aspect ratio. As shown in FIG. 6, the second FOV 104 has a width of about 25-degrees for the spot pattern light source with the 3:1 aspect ratio. FIG. 7 shows a diagram of a source emitting area and a corresponding far-field projection pattern, for a spot pattern light source 24 with a 2:1 aspect ratio. As shown in FIG. 7, the second FOV 104 has a width of about 16-degrees for the spot pattern light source with the 2:1 aspect ratio.

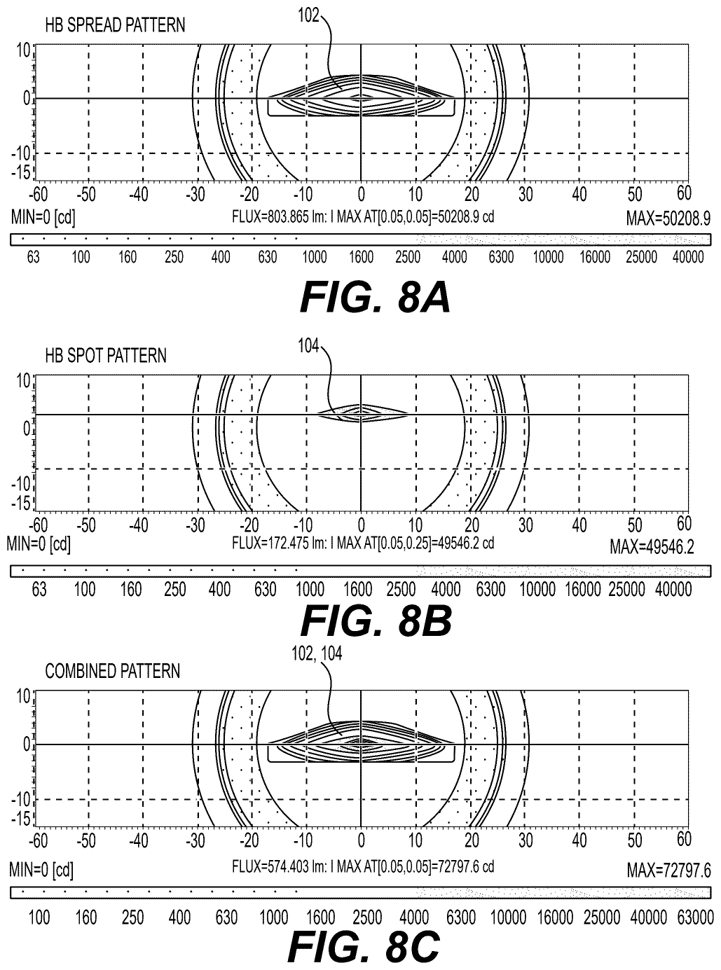

FIG. 8A shows an illumination pattern for a high-beam spread pattern illumination source, FIG. 8B shows an illumination pattern for a high-beam spot pattern illumination source, and FIG. 8C shows a combined illumination pattern for a high-beam spread pattern light source and a high-beam spot pattern illumination source.

Each of FIGS. 5-7 show projection patterns for the corresponding light source 22, 24 in a full-on condition, whereas FIGS. 8A-8C show example illumination patterns for an example use case, to generate a combined lighting pattern with a specific size, shape, and illumination profile.

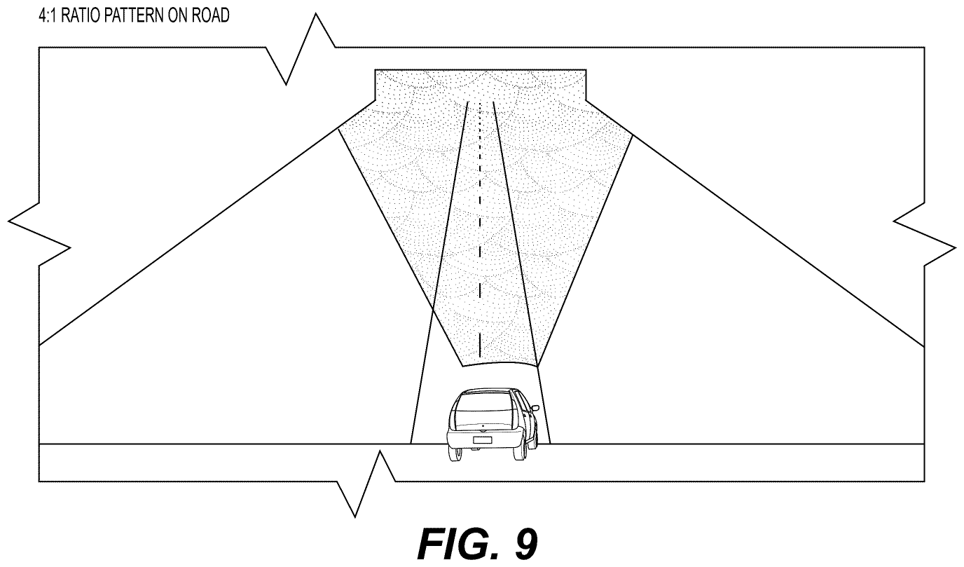

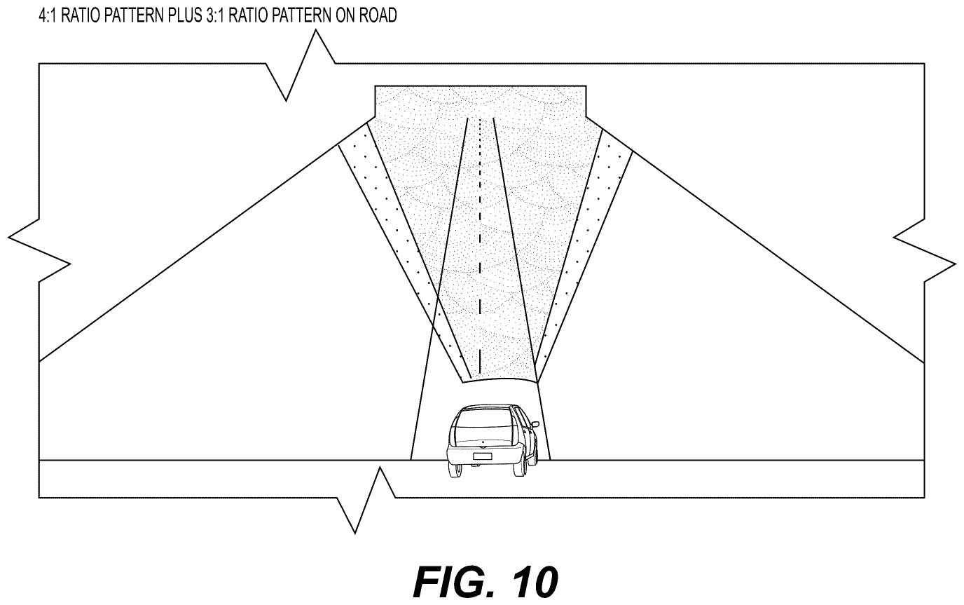

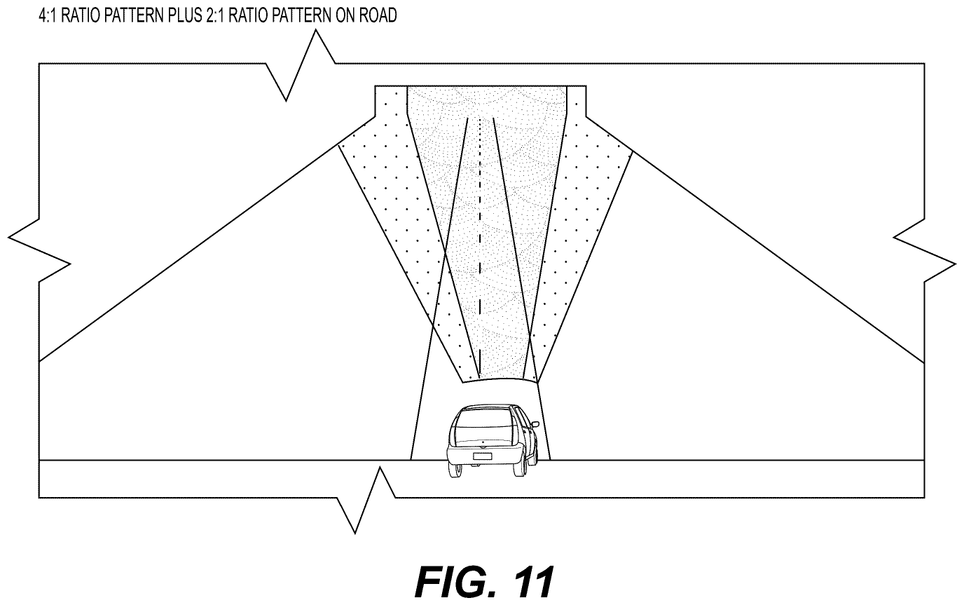

FIG. 9 shows an on-road illumination pattern for a spread pattern light source with a 4:1 aspect ratio. FIG. 10 shows an on-road combined illumination pattern for a spread pattern light source with a 4:1 aspect ratio together with a spot pattern light source with a 3:1 aspect ratio. FIG. 11 shows an on-road combined illumination pattern for a spread pattern light source with a 4:1 aspect ratio together with a spot pattern light source with a 2:1 aspect ratio.

The system, methods and/or processes described above, and steps thereof, may be realized in hardware, software or any combination of hardware and software suitable for a particular application. The hardware may include a general purpose computer and/or dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or alternatively, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices as well as heterogeneous combinations of processors processor architectures, or combinations of different hardware and software, or any other machine capable of executing program instructions.

Thus, in one aspect, each method described above and combinations thereof may be embodied in computer executable code that, when executing on one or more computing devices performs the steps thereof. In another aspect, the methods may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

The foregoing description is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A headlight assembly for a vehicle, comprising:
a spread pattern light source including a first plurality of pixel light sources;
a first lens assembly overlying the spread pattern light source and configured to project the light from the spread pattern light source over a first field of view;
a spot pattern light source including a second plurality of pixel light sources; and
a second lens assembly overlying the spot pattern light source and configured to project the light from the spot pattern light source over a second field of view smaller than the first field of view and overlapping the first field of view,
wherein the first lens assembly and the second lens assembly each have substantially identical constructions.

2. The headlight assembly of claim 1, wherein the spread pattern light source and the spot pattern light source are operable together in a high-beam mode to generate a combined high-beam projection pattern.

3. The headlight assembly of claim 1, wherein the first plurality of pixel light sources define a first aspect ratio and the second plurality of pixel light sources define a second aspect ratio different than the first aspect ratio.

4. The headlight assembly of claim 3, wherein the first aspect ratio of the spread pattern light source is greater than the second aspect ratio of the spot pattern light source.

5. The headlight assembly of claim 4, wherein the first aspect ratio of the spread pattern light source is 4:1 and the second aspect ratio of the spot pattern light source is one of 3:1 or 2:1.

6. The headlight assembly of claim 1, wherein the first plurality of pixel light sources of the spread pattern light source includes at least 1,000 pixel light sources.

7. The headlight assembly of claim 1, wherein the second plurality of pixel light sources of the spot pattern light source includes at least 1,000 pixel light sources.

8. The headlight assembly of claim 1, wherein the first field of view has a width of about 32-degrees.

9. The headlight assembly of claim 1, wherein the second field of view has a width of about 16-degrees.

10. The headlight assembly of claim 1, further comprising a controller in communication with each of the spread pattern light source and the spot pattern light source and configured to communicate pattern data thereto to adjust an illumination pattern produced by the combination of the spread pattern light source and the spot pattern light source.

11. A lighting system for a vehicle, comprising:
two headlight assemblies, with each of the headlight assemblies including:
a spread pattern light source including a first plurality of pixel light sources;
a first lens assembly overlying the spread pattern light source and configured to project the light from the spread pattern light source over a first field of view;
a spot pattern light source including a second plurality of pixel light sources; and
a second lens assembly overlying the spot pattern light source and configured to project the light from the spot pattern light source over a second field of view smaller than the first field of view and overlapping the first field of view,
wherein the first lens assembly and the second lens assembly each have substantially identical constructions.

12. The lighting system of claim 11, wherein the spread pattern light source and the spot pattern light source are operable together in a high-beam mode to generate a combined high-beam projection pattern.

13. The lighting system of claim 11, wherein the first plurality of pixel light sources define a first aspect ratio and the second plurality of pixel light sources define a second aspect ratio different than the first aspect ratio.

14. The lighting system of claim 13, wherein the first aspect ratio of the spread pattern light source is greater than the second aspect ratio of the spot pattern light source.

15. The lighting system of claim 14, wherein the first aspect ratio of the spread pattern light source is 4:1 and the second aspect ratio of the spot pattern light source is one of 3:1 or 2:1.

16. The lighting system of claim 11, wherein the first plurality of pixel light sources of the spread pattern light source includes at least 1,000 pixel light sources.

17. The lighting system of claim 11, wherein the second plurality of pixel light sources of the spot pattern light source includes at least 1,000 pixel light sources.

18. The lighting system of claim 11, wherein the first field of view has a width of at least about 32-degrees.

19. The lighting system of claim 11, wherein the second field of view has a width of at least about 16-degrees.

20. The lighting system of claim 11, further comprising a controller in communication with each of the spread pattern light source and the spot pattern light source and configured to communicate pattern data thereto to adjust an illumination pattern produced by the combination of the spread pattern light source and the spot pattern light source.
